(19) United States
(12) Patent Application Publication
(10) Pub. No.: US 2015/0113963 A1
(43) Pub. Date: Apr. 30, 2015

(54) CONTROL OF REGENERATION IN A DIESEL AFTER-TREATMENT SYSTEM

(71) Applicant: GM GLOBAL TECHNOLOGY OPERATIONS LLC, Detroit, MI (US)

(72) Inventors: Igor Anilovich, Walled Lake, MI (US); David N. Belton, Birmingham, MI (US); Vincent J. Tylutki, Livonia, MI (US); John F. Van Gilder, Webberville, MI (US)

(73) Assignee: GM GLOBAL TECHNOLOGY OPERATIONS LLC, Detroit, MI (US)

(21) Appl. No.: 14/065,814

(22) Filed: Oct. 29, 2013

(51) Int. Cl. B01D 53/94; F01N 3/10

(52) U.S. Cl. CPC B01D 53/9495; F01N 3/10
USPC 60/286; 423/212; 422/111

(57) ABSTRACT

A method is disclosed for controlling regeneration in a diesel engine after-treatment system having a diesel oxidation catalyst (DOC) and a diesel particulate filter (DPF). The method includes injecting an amount of fuel into an exhaust gas flow upstream of the DOC to superheat the gas flow and assessing a rate of the warm-up of the DOC. The method also includes determining, in response to the assessed rate of the warm-up of the DOC, an amount of catalyst substance available in the DOC for catalyzing the exhaust gas flow. The method additionally includes reducing the amount of fuel injected into the DOC such that the determined available amount of catalyst substance is utilized in the DOC for catalyzing the exhaust gas flow and a predetermined amount of fuel is permitted to slip through the DOC to maintain regeneration temperature in the DPF. A system and a vehicle are also disclosed.

### TECHNICAL FIELD

The present disclosure is drawn to a system and a method for controlling regeneration in a diesel engine after-treatment (AT) system.

### BACKGROUND

Various exhaust after-treatment devices, such as particulate filters and other devices, have been developed to effectively limit exhaust emissions from internal combustion engines.

An after-treatment system for a modern diesel engine exhaust typically incorporates a diesel oxidation catalyst (DOC) as one of the devices for such a purpose. A DOC generally contains a discrete number of sites containing precious metals, such as platinum and/or palladium, which serve as catalysts to oxidize, i.e., convert, hydrocarbons and carbon monoxide present in the exhaust flow into carbon dioxide and water. Over time, however, some precious metal sites in the DOC may become inactive. Such degradation of the DOC may be caused by elevated temperatures due to some of the engine's hydrocarbon emissions burning directly within the DOC.

An after-treatment system may also incorporate a diesel particulate filter (DPF) for collecting and disposing of the sooty particulate matter emitted by the diesel engine prior to the exhaust gas being discharged to the atmosphere. A typical DPF acts as a trap for removing the particulate matter from the exhaust stream. Similar to a DOC, the DPF contains precious metals, such as platinum and/or palladium, which serve as catalysts to further oxidize soot and hydrocarbons present in the exhaust stream. The DPF may be regenerated or cleaned using superheated exhaust gas to burn off the collected particulate.

### SUMMARY

A method is disclosed for controlling regeneration in a diesel engine after-treatment (AT) system having a diesel oxidation catalyst (DOC) and a diesel particulate filter (DPF).

The method includes commencing regeneration cycle “n”, wherein “n” is a positive integer, of the AT system by injecting an amount of fuel into an exhaust gas flow upstream of the DOC in order to superheat the exhaust gas flow and generate or cause a warm-up of the DOC. The method also includes assessing a rate of the warm-up of the DOC caused by the superheated exhaust gas flow. The method additionally includes determining, in response to the assessed rate of the warm-up of the DOC, an amount of catalyst available or active in the DOC for catalyzing the exhaust gas flow. Furthermore, the method includes reducing the amount of fuel injected into the DOC, such that the determined available amount of catalyst is utilized in the DOC for catalyzing the exhaust gas flow and a predetermined amount of fuel is permitted to slip through the DOC to maintain regeneration temperature in the DPF.

The DOC may be identified as having failed if the amount of catalyst substance available for catalyzing the exhaust gas flow is below a predetermined amount. The method may also include reducing the amount of fuel injected into the DOC to zero if the DOC has failed.

The method may also include generating a signal indicative of the DOC having failed if the amount of catalyst substance available for catalyzing the exhaust gas flow is below the predetermined amount.

Each of the acts of commencing the regeneration cycle “n” of the AT system, assessing the rate of the warm-up of the DOC, determining the amount of catalyst substance available in the DOC for catalyzing the exhaust gas flow, reducing the amount of fuel injected into the DOC, reducing the amount of fuel injected into the DOC to zero, and generating the signal indicative of the DOC having failed may be accomplished by a controller.

The regeneration of the AT system may be regulated by the controller as a closed-loop operation. Such closed-loop operation may include storing the reduced amount of fuel and commanding, via the controller, injection of the reduced amount of fuel into the DOC during a regeneration cycle “n+1” of the AT system.

The act of commencing regeneration of the AT system may be regulated by the controller as an open-loop operation. Such open-loop operation may include injecting the amount of fuel into the DOC during a regeneration cycle “n+1” of the AT system.

The amount of catalyst substance available in the DOC for catalyzing the exhaust gas flow may be identified as a discrete number of active precious metal (platinum and/or palladium for oxidizing hydrocarbons and carbon monoxide into carbon dioxide and water) sites within the DOC.

The DOC and the DPF may be located in tandem within a single canister.

A system for controlling regeneration in a diesel engine AT system and a vehicle employing such a system are also provided.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic plan view of a vehicle having a diesel engine connected to an exhaust system having an after-treatment (AT) system for reducing exhaust emissions.

FIG. 2 is a flow diagram of a method of controlling regeneration in the AT system of FIG. 1.

### DETAILED DESCRIPTION

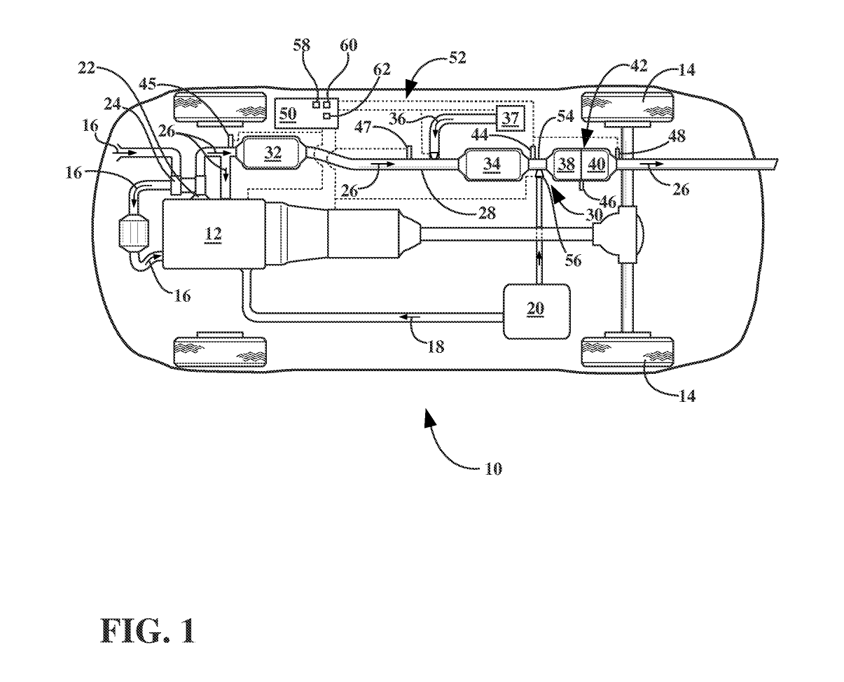

Referring to the drawings, wherein like reference numbers refer to like components throughout the several views, FIG. 1 schematically depicts a motor vehicle 10. The vehicle 10 includes a compression-ignition or diesel internal combustion engine 12 configured to propel the vehicle via driven wheels 14. Internal combustion in the diesel engine 12 occurs when a specific amount of ambient air flow 16 is mixed with a metered amount of fuel 18 supplied from a fuel tank 20 and the resultant air-fuel mixture is compressed inside the engine's cylinders (not shown).

As shown, the engine 12 includes an exhaust manifold 22 and a turbocharger 24. The turbocharger 24 is energized by an exhaust gas flow 26 that is released by individual cylinders of the engine 12 through the exhaust manifold 22 following each combustion event. The turbocharger 24 is connected to an exhaust system 28 that receives exhaust gas flow 26 and eventually releases the gas flow to the ambient, typically on a side or aft of the vehicle 10. Although the engine 12 is depicted as having the exhaust manifold 22 attached to the engine structure, the engine may include exhaust passages (not shown) such as generally formed in exhaust manifolds. In such a case, the above passages may be incorporated into the engine structure, such as the engine's cylinder head(s). Furthermore, although the turbocharger 24 is shown, nothing precludes the engine 12 from being configured and operated without such a power augmentation device.

The vehicle 10 also includes a diesel engine after-treatment (AT) system 30. The AT system 30 includes a number of exhaust after-treatment devices configured to methodically remove largely carbonaceous particulate byproducts and emission constituents of engine combustion from the exhaust gas flow 26. As shown, the AT system 30 operates as part of the exhaust system 28, and includes a diesel oxidation catalyst (DOC) 32. The primary function of the DOC 32 is reduction of carbon monoxides (CO) and non-methane hydrocarbons (NMHC). Additionally, the DOC 32 is configured to generate nitrogen dioxide (NO₂), which is required by a selective catalytic reduction (SCR) catalyst 34 that is arranged downstream of the DOC 32. The DOC 32 typically contains a catalyst substance made up of precious metals, such as platinum and/or palladium, which function therein to accomplish the above-noted objectives. Generally, with respect to generation of NO₂, the DOC 32 becomes activated and reaches operating efficiency at elevated temperatures. Therefore, as shown in FIG. 1, the DOC 32 may be close-coupled to the turbocharger 24 in order to reduce loss of thermal energy from the exhaust gas flow 26 prior to the gas reaching the DOC.

The SCR catalyst 34, on the other hand, is configured to convert NO_{X} into diatomic nitrogen (N₂) and water (H₂O) with the aid of the NO₂ generated by the DOC 32. The SCR conversion process additionally requires a controlled or metered amount of a reductant having a general name of “diesel-exhaust-fluid” (DEF) 36 when the reductant is employed in diesel engines. The DEF 36 may be an aqueous solution of urea that includes water and ammonia (NH₃). The DEF 36 is injected into the exhaust gas flow 26 from a reservoir 37 at a location in the AT system 30 that is downstream of the DOC 32 and upstream of the SCR catalyst 34. Accordingly, the DEF 36 accesses the SCR catalyst 34 as the exhaust gas flow 26 flows through the SCR catalyst. An inner surface of the SCR catalyst 34 includes a wash coat that serves to attract the DEF 36 such that the DEF may interact with the exhaust gas flow 26 in the presence of NO and NO₂, and generate a chemical reaction to reduce NO_{X} emissions from the engine 12.

After the SCR catalyst 34, the exhaust gas flow 26 proceeds to a second diesel oxidation catalyst (DOC) 38 arranged in tandem with and upstream of a diesel particulate filter (DPF) 40. The DOC 38 and DPF 40 may be housed inside a single canister 42, as shown in FIG. 1. The DOC 38 is configured to oxidize hydrocarbons and carbon monoxide present in the exhaust gas flow 26 into carbon dioxide (CO₂) and water. The DPF 40 is configured to collect and dispose of the particulate matter emitted by the engine 12 prior to the exhaust gas flow 26 being discharged to the atmosphere. Accordingly, the DPF 40 acts as a trap for removing the particulate matter, specifically, soot, from the exhaust flow. Similar to the DOC 32 described above, each of the DOC 38 and the DPF 40 typically contains precious metals, such as platinum and/or palladium, which function as catalysts in the subject devices to accomplish their respective objectives. After passing through the DOC 38 and DPF 40 inside the canister 42, the exhaust gas flow 26 is deemed to be sufficiently cleaned of the noxious particulate matter and may then be allowed to exit the exhaust system 28 to the atmosphere.

The AT system 30 also includes a first temperature probe 44 configured to sense an inlet temperature of the DOC 38 and a second temperature probe 46 configured to sense an outlet temperature of the DOC 38. Additionally, the AT system 30 includes a third temperature probe 48 configured to sense an outlet temperature of the DPF 40. Furthermore, the AT system 30 may include a temperature probe 45 configured to sense an inlet temperature at the DOC 32 and a temperature probe 47 configured to sense an outlet temperature of the DOC 32 and an inlet temperature at the SCR 34.

The AT system also 30 includes a controller 50. The controller 50 may be a stand-alone unit, or be part of an electronic controller that regulates the operation of engine 12. Additionally, the controller 50 is programmed to regulate operation of the engine 12, as well as operation of the exhaust after-treatment devices, namely the DOC 32, SCR catalyst 34, DOC 38, and DPF 40. Each of the first, second, and third temperature probes 44, 46, 48, as well as the probes 45 and 47, is in electrical communication with the controller 50 in order to facilitate regulation of the AT system 30 by the controller.

During operation of the engine 12, hydrocarbons emitted by the engine 12 may at times become deposited on the DPF 40 and consequently affect operating efficiency of the AT system 30. Accordingly, the DPF 40 must be regenerated or cleaned after some particular amount of carbon-based soot is accumulated thereon to burn off the collected particulates. Regeneration of an exhaust after-treatment device may, for example, be commenced after a specific mass flow of air has been consumed by the engine for combustion over a period of time. Generally, such regeneration may be accomplished using high temperature exhaust gas flow to burn off the accumulated particles. The DPF 40 may be regenerated via fuel being injected directly into the exhaust gas flow upstream of the DPF and then having the injected fuel ignited at an appropriate instance.

The vehicle 10 also includes a system 52 configured to assess and diagnose the state of NMHC conversion efficiency in the DOC 38. The system 52 includes the DOC 38, the DPF 40, the first and second temperature probes 44 and 46, as well as the controller 50. The system 52 also includes a passage 54 that is part of the exhaust system 28 and configured to carry the exhaust gas flow 26 from the SCR catalyst 34 to the canister 42. The passage 54 includes a specific device such as an HC injector 56 configured to selectively inject a predetermined amount of diesel fuel into passage 54 upstream of the DOC 38 in order to superheat the exhaust gas flow 26 and perform regeneration of the AT system 30, specifically of the DPF 40. The controller 50 may regulate operation of the HC injector 56 to commence or trigger regeneration of the AT system 30 when such is deemed appropriate.

Any regeneration iteration or cycle “n”, wherein “n” is a positive integer, commences with the controller 50 commanding the HC injector 56 to inject an amount of fuel into an exhaust gas flow 26 upstream of the DOC 38 in order to superheat the exhaust gas flow and generate a warm-up of the DOC. The controller 50 may commence a regeneration cycle “n” and a subsequent cycle “n+1” according to a schedule programmed into the controller or based on assessed operation of the engine 12 and the AT system 30. The controller 50 is also programmed to perform a diagnostic procedure configured to monitor an operating status of the DOC 38. During the diagnostic procedure, the controller 50 monitors inlet and outlet temperatures of the DOC 38 during the regeneration process via the first and second temperature probes 44, 46, respectively.

The controller 50 also assesses a rate of warm-up of the DOC 38 caused by the superheated exhaust gas flow 26 during initial stages of the regeneration process. In order to assess the rate of DOC 38 warm-up, the controller 50 uses temperature data from the first and second temperature probes 44, 46 to determine how the difference between the two probe readings changes during a specific time frame. The controller 50 also compares the assessed rate of warm-up of the DOC 38 with stored reference warm-up rates of the DOC. The stored reference warm-up rates of the DOC 38 may be calculated empirically and correlated to an amount of the catalyst substance available or active in the DOC for oxidizing hydrocarbons and carbon monoxide into carbon dioxide and water, as well as an increase in inlet temperature at the DPF 40 that is required for efficient regeneration of the DPF.

The threshold DOC 38 inlet/outlet temperature difference and the attendant rate of warm-up may also be established empirically by testing a sample DOC having a variable active number of platinum and/or palladium sites. Furthermore, the generated reference results may be programmed into the controller 50 as a look-up table 58 correlating the warm-up and conversion efficiency of the DOC 38 to the number of active platinum and/or palladium sites available within the subject DOC. Subsequently, during operation of the AT system 30, in response to the assessed rate of warm-up of the DOC 38 and via comparison with the reference warm-up rates of the DOC, the controller 50 may determine an amount of catalyst substance available in the DOC for catalyzing the exhaust gas flow 26 and the corresponding DOC conversion efficiency.

A threshold DOC 38 warm-up rate 60 signifying a value below which the amount of the catalyst substance remaining in the DOC is considered to no longer be capable of supporting the requisite exothermal chemical reaction may also be stored within the controller 50. If the assessed rate of warm-up of the DOC 38 is at or above the threshold DOC warm-up rate 60, the DOC 38 is deemed to be functional and in no need of replacement. The amount of catalyst substance available in the DOC 38 may be identified as a discrete number of platinum and/or palladium cells or sites that remain active within the DOC for catalyzing the exhaust gas flow 26.

The controller 50 is also programmed to adjust the amount of diesel fuel injected by the HC injector 56 into passage 54 in response to the assessed operating status of the DOC 38. Thus adjusted, the amount of fuel that is injected into the DOC 38 is such that the determined available amount of catalyst substance is efficiently utilized in the DOC for catalyzing the exhaust gas flow 26. Furthermore, the amount of fuel injected into the DOC 38 is adjusted in order to permit a predetermined amount of fuel to slip through the DOC into the passage 54. Such a predetermined amount of fuel that is slipped through the DOC 38 is beneficial in maintaining appropriate reaction temperature in the DPF 40, which may be monitored via the third temperature probe 48, during the latter stages of the regeneration cycle.

Generally, with respect to the permitted amount of fuel slip through the DOC 38, the objective is to reduce the amount of fuel slip in order to minimize impact on exhaust emissions, while retaining a sufficient amount of fuel to assist controllable soot burning inside the DPF 40. The predetermined amount of fuel that would be permitted to slip through the DOC 38 is generally a function of such factors as exhaust flow, target inlet temperature at the DPF 40, soot level in the DPF, and physical characteristics of the subject DPF. Therefore, the specific amount of fuel that would be permitted to slip through the DOC 38 is typically determined empirically during appropriate testing and validation of the AT system 30.

The controller 50 is additionally configured to determine or identify when the available amount of catalyst substance located within the precious metal sites, i.e., remain active in the DOC 38 for catalyzing the exhaust gas flow 26, drops below a threshold amount. An assessment of the number of active precious metal sites remaining active within the DOC 38 may be based on the reference warm-up rates of the DOC compiled in the look-up table 58 and stored within the controller 50 and a particular or current warm-up rate being below the threshold DOC warm-up rate 60. Such a reduction below the threshold number of active precious metal sites in the DOC 38 signifies that the catalyst has failed. In response to the detected drop in the available amount of catalyst substance below the threshold amount, the controller 50 may reduce the amount of fuel injected into the DOC 38 to zero. In the event that the detected number of active precious metal sites has dropped, but still remains above the threshold amount, the amount of injected fuel may be reduced by the controller 50 appropriately, such as in proportion to the number of precious metal sites that no longer remain active.

In general, the DOC 38 would need to degrade significantly, with the active precious metal sites having fallen below the threshold number, before fuel injection would have to be fully discontinued. Additionally, although an alert or signal 62 may be triggered by the controller 50 for a DOC 38 having a reduced number of active precious metal sites, which necessitates the reduced amount of injected fuel, such a DOC could still be used for regeneration of the DPF 40. However, when the DOC 38 degrades even further, to the level where the number of active precious metal sites has dropped below the threshold number, and the DOC can no longer generate an outlet temperature that is sufficiently high for the regeneration of the DPF 40, then the injection of fuel would be fully discontinued, i.e., reduced to zero.

As mentioned above, the controller 50 may be configured to generate the signal 62 indicative of the DOC 38 having failed, in the event that the amount of catalyst substance available in the DOC has dropped below the threshold amount. The signal 62 generated by the controller 50 may be designed to inform service personnel and/or operator of the vehicle 10 regarding the state of operating efficiency of the DOC 38. Furthermore, the signal 62 may be a predetermined diagnostic numerical code, or a visual or audible display for service personnel and/or operator of the vehicle 10 that is indicative of the DOC 38 having failed.

The controller 50 may be configured to regulate regeneration of the AT system 30 as a closed-loop or feed back operation. During such closed-loop operation, the controller 50 stores the adjusted amount of fuel and commands an injection of the adjusted amount of fuel into the DOC 38 during the DOC warm-up portion of the regeneration cycle “n+1” of the AT system 30. Accordingly, during closed-loop operation, the amount of fuel being injected into the exhaust gas flow 26 upstream of the DOC 38 for assessing the DOC's rate of warm-up during the current regeneration cycle is the value for the amount fuel that was modified and used during the preceding cycle “n”. In a separate embodiment, the controller 50 may be configured to regulate regeneration of the AT system 30 as an open-loop operation. During such open-loop operation, the controller 50 commands an injection of the same amount of fuel into the DOC 38 during the DOC warm-up portion of the regeneration cycle “n+1” as was used during the DOC warm-up portion of the preceding regeneration cycle “n”.

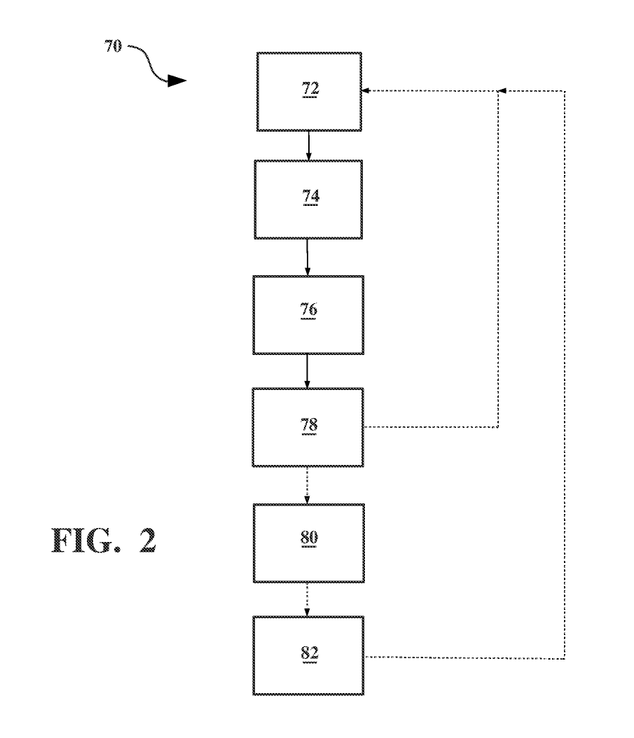

FIG. 2 depicts a method 70 of controlling regeneration in the diesel engine AT system 30, as described above with respect to FIG. 1. The method initiates in frame 72, where it includes commencing regeneration cycle “n” of the AT system 30 by injecting an amount of fuel into the exhaust gas flow 26 upstream of the DOC 38. As described above, the injected fuel is intended to superheat the exhaust gas flow 26 and cause a warm-up of the DOC 38. Following frame 72, the method proceeds to frame 74, where it includes assessing and monitoring a rate of the warm-up of the DOC 38 caused by the superheated exhaust gas flow 26.

After frame 74, the method advances to frame 76. In frame 76, the method includes determining, in response to the assessed rate of the warm-up of the DOC 38, an amount of catalyst substance available in the DOC for catalyzing the exhaust gas flow 26. Following frame 76 the method proceeds to frame 78, where the method includes reducing the amount of fuel injected into the DOC 38 such that the determined available amount of catalyst substance is utilized in the DOC for catalyzing the exhaust gas flow 26. Furthermore, as described above with respect to FIG. 1, adjusting the amount of fuel that is injected into the DOC 38 is accomplished such that a predetermined amount of fuel is permitted to slip through the DOC to maintain regeneration temperature in the DPF 40.

The regeneration temperature of the DPF 40 may be monitored via the third temperature probe 48. The controller may additionally determine whether in frame 78 the amount of fuel injected into the DOC 38 needed to be reduced because the amount of the catalyst substance available in the DOC 38 has dropped below a first threshold. If the amount of the catalyst substance available in the DOC 38 was determined to be below the first threshold, the controller 50 may generate a signal or diagnostic code indicative of the emission performance of the DOC 38 having degraded.

Following frame 78 the method may proceed to frame 80, where the controller 50 assesses whether the DOC 38 has failed if the amount of catalyst substance available for catalyzing the exhaust gas flow 26 is below a second threshold amount. If in frame 80 the controller 50 has identified that the DOC 38 has failed, i.e., the number of active precious metal sites has fallen below the second threshold amount such that the DOC cannot generate sufficient outlet temperature for regeneration of the DPF 40, the method may advance to frame 82. In frame 82 the controller 50 reduces the amount of fuel injected into the DOC 38 down to zero.

Following either frame 78 or 82, the method may loop back to frame 72. Once the method returns to frame 72, the controller may employ either the closed-loop or the open-loop operation to regulate the subsequent cycle “n+1” regeneration cycle, as described in detail above with respect to AT system 30 shown in FIG. 1. Accordingly, the controller 50 may be programmed to continuously monitor the operation of the engine 12 and the AT system 30 to trigger the subsequent regeneration cycle “n+1”.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A method of controlling regeneration in a diesel engine after-treatment (AT) system having a controller, a diesel oxidation catalyst (DOC), and a diesel particulate filter (DPF), the method comprising:
commencing, via a controller, a regeneration cycle “n”, wherein “n” is a positive integer, of the AT system by injecting an amount of fuel into an exhaust gas flow upstream of the DOC in order to superheat the exhaust gas flow and cause a warm-up of the DOC;
assessing, via the controller, a rate of the warm-up of the DOC caused by the superheated exhaust gas flow;
determining, via the controller, in response to the assessed rate of the warm-up of the DOC, an amount of catalyst substance available in the DOC for catalyzing the exhaust gas flow; and
reducing, via the controller, the amount of fuel injected into the DOC such that the determined available amount of catalyst substance is utilized in the DOC for catalyzing the exhaust gas flow and a predetermined amount of fuel is permitted to slip through the DOC to maintain regeneration temperature in the DPF.

2. The method of claim 1, wherein the DOC is identified to have failed if the amount of catalyst substance available for catalyzing the exhaust gas flow is below a threshold amount, further comprising reducing the amount of fuel injected into the DOC to zero if the DOC has failed.

3. The method of claim 2, further comprising generating a signal indicative of the DOC having failed if the amount of catalyst substance available in the DOC for catalyzing the exhaust gas flow is below the threshold amount.

4. The method of claim 3, wherein each of said reducing the amount of fuel injected into the DOC to zero and generating the signal indicative of the DOC having failed is accomplished by the controller.

5. The method of claim 4, wherein the regeneration of the AT system is regulated by the controller as a closed-loop operation.

6. The method of claim 5, wherein the closed-loop operation includes storing the reduced amount of fuel and commanding via the controller injection of the reduced amount of fuel into the DOC during a regeneration cycle “n+1” of the AT system.

7. The method of claim 4, wherein the regeneration of the AT system is regulated by the controller as an open-loop operation.

8. The method of claim 7, wherein the open-loop operation includes injecting the amount of fuel into the DOC during a regeneration cycle “n+1” of the AT system.

9. The method of claim 1, wherein the amount of catalyst substance available in the DOC for catalyzing the exhaust gas flow is identified as a discrete number of active precious metal sites within the DOC, and wherein said determining the amount of catalyst substance available in the DOC for catalyzing the exhaust gas flow is accomplished via a look-up table correlating the rate of warm-up of the DOC to the number of active precious metal sites within the DOC.

10. A system for controlling regeneration in a diesel engine after-treatment (AT) system, the system comprising:
a passage configured to carry an exhaust gas flow from the engine and an injection of diesel fuel for introduction into the AT system, wherein the AT system includes a diesel oxidation catalyst (DOC) arranged upstream of a diesel particulate filter (DPF);
a device configured to inject diesel fuel into the passage; and
a controller configured to:
commence a regeneration cycle “n”, wherein “n” is a positive integer, of the AT system by injecting an amount of fuel into an exhaust gas flow upstream of the DOC in order to superheat the exhaust gas flow and cause a warm-up of the DOC;
assess a rate of warm-up of the DOC caused by the superheated exhaust gas flow;
determine, in response to the assessed rate of warm-up of the DOC, an amount of catalyst substance available in the DOC for catalyzing the exhaust gas flow; and
reduce the amount of fuel injected into the DOC such that the determined available amount of catalyst substance is utilized in the DOC for catalyzing the exhaust gas flow and a predetermined amount of fuel is permitted to slip through the DOC to maintain regeneration temperature in the DPF.

11. The system of claim 10, wherein the controller is additionally configured to identify that the DOC has failed if the amount of catalyst substance available for catalyzing the exhaust gas flow is below a threshold amount and reduce the amount of fuel injected into the DOC to zero if the DOC has failed.

12. The system of claim 11, wherein the controller is additionally configured to generate a signal indicative of the DOC having failed if the amount of catalyst substance available for catalyzing the exhaust gas flow is below the threshold amount.

13. The system of claim 10, wherein the controller is configured to regulate regeneration of the AT system via a closed-loop operation.

14. The system of claim 13, wherein during the closed-loop operation the controller stores the reduced amount of fuel and commands an injection of the reduced amount of fuel into the DOC during a regeneration “n+1” of the AT system.

15. The system of claim 10, wherein the controller is configured to regulate regeneration of the AT system via an open-loop operation.

16. The system of claim 15, wherein during the open-loop operation the controller commands an injection of the amount of fuel into the DOC during a regeneration cycle “n+1” of the AT system.

17. The system of claim 10, wherein the amount of catalyst substance available in the DOC for catalyzing the exhaust gas flow is identified via the controller as a discrete number of active precious metal sites within the DOC, and wherein the controller determines the amount of catalyst substance available in the DOC for catalyzing the exhaust gas flow via a look-up table correlating the rate of warm-up of the DOC to the number of active precious metal sites within the DOC.

18. A vehicle comprising:
a diesel engine configured to propel the vehicle;
an after-treatment (AT) system having a diesel oxidation catalyst (DOC) arranged upstream of a diesel particulate filter (DPF);
a passage configured to carry an exhaust gas flow from the engine and an injection of diesel fuel for introduction into the AT system;
a device configured to inject diesel fuel into the passage; and
a controller configured to:
commence a regeneration cycle “n”, wherein “n” is a positive integer, of the AT system by injecting an amount of fuel into an exhaust gas flow upstream of the DOC in order to superheat the exhaust gas flow and cause a warm-up of the DOC;
assess a rate of warm-up of the DOC caused by the superheated exhaust gas flow;
determine, in response to the assessed rate of warm-up of the DOC, an amount of catalyst substance available in the DOC for the exhaust gas flow; and
reduce the amount of fuel injected into the DOC such that the determined available amount of catalyst substance is utilized in the DOC for catalyzing the exhaust gas flow and a predetermined amount of fuel is permitted to slip through the DOC to maintain regeneration temperature in the DPF.

19. The vehicle of claim 18, wherein the controller is configured to commence regeneration of the AT system via a closed-loop such that the controller stores the reduced amount of fuel and commands an injection of the adjusted amount of fuel into the DOC during a regeneration cycle “n+1” of the AT system.

20. The vehicle of claim 18, wherein the controller is configured to commence regeneration of the AT system via an open-loop operation such that the controller commands an injection of the amount of fuel into the DOC during a regeneration cycle “n+1” of the AT system.
